(19) United States
(12) Patent Application Publication
(10) Pub. No.: US 2009/0199707 A1
(43) Pub. Date: Aug. 13, 2009

(54) Bleeding System For A Hydraulic Steering System

(76) Inventor: Roger Kollmeier, Stuttgart (DE)

Correspondence Address: ROBERT W. BECKER & ASSOCIATES, 707 HIGHWAY 333, SUITE B, TIJERAS, NM, 87059-7507, US

(21) Appl. No.: 12/306,662

(22) PCT Filed: Mar. 14, 2007
(86) PCT No.: PCT/EP07/02254

§ 371 Date: Dec. 24, 2008

(30) Foreign Application Priority Data
Jun. 28, 2006 (DE) 10 2006 030 125.0

(51) Int. Cl. F15B 21/04

(52) U.S. Cl. 92/163

(57) ABSTRACT

A hydraulic working cylinder of a steering system for a motor vehicle, wherein a piston having a piston rod is displaceably disposed in the working cylinder and the working cylinder has a working chamber into which leads at least one line connection for supply and discharge of pressurized medium. A ring is disposed in the working chamber, and a groove is provided in an inner wall of the working cylinder and is in communication with the line connection. The groove extends from the line connection to an upper region of the working chamber, and the ring closes off the groove relative to the working chamber with the exception of an upper region of the groove that is disposed adjacent to the upper region of the working chamber.

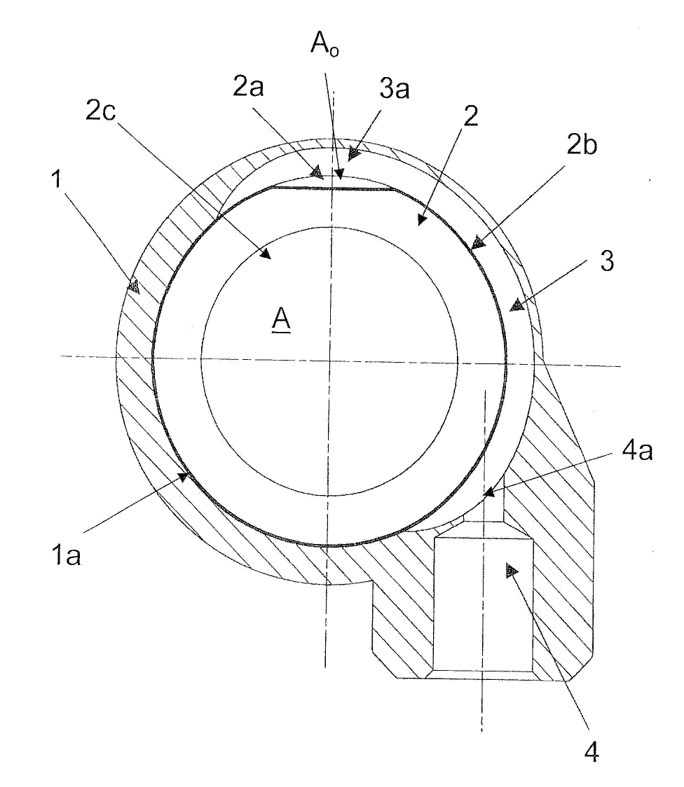

The present invention relates to a hydraulic working cylinder in accordance with the preamble to claim 1.

A generic working cylinder is known from DE 44 19 214 A1, in which a ring with a circumferential groove in the casing surface of the ring is arranged in the working cylinder, wherein the groove is connected to a line connection and the ring has in its upper region a cut-out extending in the axial direction, which engages through the axial delimitation wall of the groove in the ring, in such a way that the upper region of the groove is connected to the upper region of the working cylinder, such that air collecting in the upper region of the working cylinder can be bled via the channel out of the working cylinder.

The design of the ring is elaborate, wherein the ring additionally has a relatively large axial thickness.

The invention is based on the object of providing a hydraulic working cylinder with self-bleeding which consists of components which are simple to manufacture.

This object is resolved by a hydraulic working cylinder in accordance with claim 1. Further advantageous embodiments are derived from the features of the sub-claims.

An advantage of the working cylinder according to the invention is that the ring is simple to manufacture and the groove in the inside wall of the working cylinder can be easily produced with the manufacturing process for manufacturing the working cylinder.

The connection of the groove to the working cylinder in its upper region can be effected either by means of an at least partial flattening of the ring or by means of a channel or hole in the ring.

The arrangement of the line connection can in principle be arbitrary. The ring does not have to be manufactured separately for this purpose. This advantageously results in substantial room for maneuver for the arrangement of the line connection, wherein the ring does not need to be changed in its design. As a result of this, the ring can be universally used for the most widely differing designs of steering systems.

It is also possible for the ring to be integrated into a sealing element for the working cylinder or for a sealing element to assume the function of the ring by it being designed to correspond to the ring in the upper region.

A possible embodiment of the hydraulic working cylinder according to the invention is explained hereinafter on the basis of the drawing.

The upper region A₀ of the working chamber A and the oil line connection 4 pertaining, to it are connected to one another by means of a channel 3. The channel 3 is formed by a groove 3 which is arranged in the inside or inner wall 1a of the working chamber A, in particular worked into, and is covered or closed relative to the working chamber A by means of a ring 2. The ring 2 has in the upper region 2a a flattening, such that the working chamber A is connected to the channel region 3a. In an alternative embodiment, the Connection can also be realized by means of a hole, which is arranged in the ring 2 in its upper region.

Due to the embodiments described heretofore, the hydraulic oil flows only from the upper region A₀ of the working chamber A via the groove to and from the oil connection 4.

As an alternative, the ring can also be integrated in a sealing element for the working chamber. It is also possible for the sealing element to assume the function of the ring, wherein the groove must then be arranged in the region of the sealing element.

The oil connection 4 can be located around the working chamber 4 of the steering gear.

1-7. (canceled)

8. A hydraulic working cylinder of a steering system for a motor vehicle, wherein a piston having a piston rod is displaceably disposed in said working cylinder and said working cylinder has a working chamber into which leads at least one line connection for supply and discharge of pressurized medium, said working cylinder further comprising:
a ring disposed in said working chamber; and
a groove provided in an inner wall of said working cylinder and in communication with said at least one line connection, wherein said groove extends from said at least one line connection to an upper region of said working chamber, and wherein said ring closes off said groove relative to said working chamber with the exception of an upper region of said groove that is disposed adjacent to said upper region of said working chamber.

9. A hydraulic working cylinder according to claim 8, wherein at least a portion of an upper region of said ring, adjacent to said upper region of said groove, is provided with a flattening, and wherein an outer surface of said ring, in the region of said flattening, does not rest against said inner wall of said working cylinder.

10. A hydraulic working cylinder according to claim 9, wherein said ring is integrated in a sealing element for said working chamber.

11. A hydraulic working cylinder according to claim 9, wherein said ring is a sealing element.

12. A hydraulic working cylinder according to claim 9, wherein said groove in said inner wall of said working cylinder extends over the entire circumference of said inner wall.

13. A hydraulic working cylinder according to claim 9, wherein said groove in said inner wall of said working cylinder extends over a portion of the circumference of said inner wall.

14. A hydraulic working cylinder according to claim 13, wherein said groove extends over 90 to 250 degrees of the circumference of said inner wall.

15. A hydraulic working cylinder according to claim 14, wherein said groove extends over 120 to 180 degrees of the circumference of said inner wall.

16. A hydraulic working cylinder according to claim 9, wherein said ring is integrated in a radial shaft sealing ring, or is embodied as a radial shaft sealing ring.
